(19) United States
(12) Patent Application Publication
(10) Pub. No.: US 2024/0001526 A1
(43) Pub. Date: Jan. 4, 2024

(54) POWER TOOL HAVING A FIRST HANDLE, A SECOND HANDLE, AND A MAIN BODY

(71) Applicant: Hilti Aktiengesellschaft, Schaan (LI)

(72) Inventors: Roland MEUER, Ettringen (DE); Michael LANZINGER, Neufraunhofen (DE)

(21) Appl. No.: 18/039,363

(22) PCT Filed: Nov. 17, 2021
(86) PCT No.: PCT/EP2021/081926

§ 371 Date: May 30, 2023

(30) Foreign Application Priority Data
Dec. 4, 2020 (EP) 20211900.4

(51) Int. Cl. B25F 5/02; B24B 23/02

(52) U.S. Cl. CPC B25F 5/02; B24B 23/028

(57) ABSTRACT

A power tool having a first handle, a second handle, and a main body, wherein the second handle projects beyond a rear side of the main body of the power tool by a length a in order to protect the power tool in the event of a fall. In other words, this means that the second handle projects beyond the main body of the power tool in a rear spatial direction and thus forms an overlap to protect the power tool and especially the rechargeable batteries thereof.

The present invention relates to a power tool having a first handle, a second handle, and a main body.

### BACKGROUND

The prior art includes power tools which are used, for example, to machine substrates or workpieces. Hand-held power tools, in particular, generally have one or more handles, by means of which the power tools can be held and/or guided. In the prior art, it is known that the handles of the power tools comprise operating switches, by means of which a user can switch the power tool on or off, for example.

Particularly in the case of cut-off grinders, which have a cutting disk as a disk-shaped tool, there is a known practice of providing two handles on the power tool. However, such provision of two handles can also be employed in other power tools, preferably on power tools in which the tool is arranged in a forward region of the power tool. These can be various saws, for example, as well as other cutting or severing units.

### SUMMARY OF THE INVENTION

In the case of such power tools with two handles, the prior art includes, in particular, two handle arrangements, namely the rear-handle arrangement and the top-handle arrangement. However, both types of arrangement are subject to individual disadvantages. In particular, neither of the two arrangements mentioned combines a desirable short overall length of the power tool with a likewise desirable ergonomic construction.

Although power tools with a rear-handle arrangement ensure a sufficient spacing between the front and the rear handle, they are generally significantly longer than top-handle power tools. Top-handle power tools, for their part, offer an inadequate hand spacing between the two handles. Specifically in the case of power tools with a top-handle configuration, the handle often makes no contribution to protecting the power tool or the rechargeable batteries when it is a matter of a battery-operated power tool.

Moreover, those in the industry would welcome it if it were possible to provide a novel handle concept for two-handled power tools, by means of which it is possible to enhance the robustness of the power tool, in particular to protect the rechargeable batteries when it is a matter of a battery-operated power tool.

An object on which the present invention is based is that of overcoming the above-described defects and disadvantages of the prior art and of providing a power tool in which a short overall length is combined with an ergonomic construction. In addition, the intention is to enhance the robustness of the power tool in order to protect the power tool and any rechargeable batteries present in an effective manner from falls and mechanical damage.

According to the invention, a power tool having a first handle, a second handle, and a main body is provided. The power tool is characterized in that the second handle projects beyond a rear side of the main body of the power tool by a length a in order to protect the power tool in the event of a fall. For the purposes of the invention, this preferably means that the second handle projects beyond the main body of the power tool in a rearward spatial direction and thus forms an overlap. The overlap preferably has the length a by which the second handle projects beyond the rear side of the main body of the power tool.

Underlying the invention is the basic concept of extending the rear handle in a “rearward” spatial direction beyond the body of the power tool in order to achieve a spacing between the first and the second handle of the power tool which is desirable for ergonomic reasons. This ergonomically desirable spacing can be achieved, in particular, by the fact that the first handle and the second handle of the power tool have a spacing L in a range of from 180 to 350 mm, preferably in a range of from 200 to 300 mm, and most preferably in a range of from 230 to 260 mm. In tests, spacings of 24-25 cm have proven the best for holding by the user during work with the power tool. One significant advantage of the invention thus consists in optimized spacings between the two gripping positions of the left and right hands of the operator, thereby making possible particularly fatigue-free working. Moreover, tests have shown that, when working with the power tool, the user can keep “on track” better if the gripping positions of the left and right hands do not go below a minimum spacing L, i.e. if the spacing L is in a range of 24-25 cm, for example. For the purposes of the invention, the spacing L is preferably set between a highest point of the first handle and a central region of the grip region of the second handle. This central region of the grip region of the second handle can preferably coincide with a central point of an upper operating switch on the upper side of the second handle. The central region of the grip region of the second handle can furthermore coincide with the rear side of the main body of the power tool.

For the purposes of the invention, it is preferred that the length L begins in the region of the front handle. The end of the length L can be defined, for example, by the location on the second handle at which a center of a palm of a user comes to rest during work with the power tool. In other words, the end of the length L lies approximately in the center of the grip region of the second handle, wherein operating or locking switches for the power tool can also be situated there.

Furthermore, tests have shown that the end of the second handle projecting beyond the rear side of the main body of the power tool is advantageously particularly robust and, at the same time, is optimized in respect of possible force absorption in the event of a fall of the power tool during which the power tool falls on its rear side. For the purposes of the invention, such a fall is preferably referred to as a “backward fall”.

The invention relates, in particular, to a novel arrangement of two handles in the region of the power tools. The power tool can preferably be a hand-held, battery- or rechargeable-battery-operated power tool, such as a cut-off grinder or a saw. By means of the arrangement, the robustness of the power tool in the event of a backward fall is significantly improved and, in addition, particularly ergonomic handling of the power tool is made possible.

For the purposes of the invention, it is preferred that the length a by which the second handle projects beyond the rear side of the main body of the power tool is in a range of from 30 to 100 mm, preferably in a range of from 50 to 80 mm, and most preferably in a range of from 55 to 70 mm. Drop tests have shown that, in particular, an overlap of the second handle by a length a in a range of from 6 to 7 cm leads to particularly effective protection of the rechargeable batteries.

One significant advantage of the invention is that the rear region of the power tool and the rechargeable batteries, which are preferably mounted in a rear and/or lower region of the main body of the power tool, can be protected very well in the event of a fall since the rechargeable batteries are not the component of the power tool which makes contact with the ground first in the event of a fall. As a result, a large part of the energy which is released as the power tool falls is absorbed by the rear handle of the power tool. The energy released is absorbed, in particular, by the rear side region of the second handle and by its rounded region. The second handle is of particularly robust design for this purpose and forms an overlap to enable the earliest contact with the substrate to be ensured in the event of a fall.

In the context of the present invention, a power tool having a first rechargeable battery and a second rechargeable battery as energy sources is provided, in particular. Furthermore, the power tool has a main body and a motor, wherein the main body has a first receiving space for receiving the first rechargeable battery, and a second receiving space for receiving the second rechargeable battery, wherein the receiving spaces are arranged in such a way within a housing of the main body that the rechargeable batteries are accessible and replaceable from a rear side of the main body, wherein the receiving spaces for the rechargeable batteries form a lower boundary of the main body of the power tool. For the purposes of the invention, this means that the receiving spaces for the rechargeable batteries or the rechargeable batteries themselves are arranged in a lower, rear region of the main body, where they are particularly well protected against falling, moisture or the like. For the purposes of the invention, it is preferred that the rechargeable batteries are arranged in spatial proximity to an underside and on the rear side of the main body of the power tool, as a result of which, on the one hand, the rechargeable batteries are protected in an optimum manner from mechanical stresses, e.g. in the event of a fall, and, on the other hand, are protected in an optimum manner from humidity, moisture and rain.

For the purposes of the invention, it is preferred that the power tool is a cut-off grinder. The grinder can comprise a rear region, which is formed by a main body and a protection frame, for example. The main body of the cut-off grinder can be surrounded by a housing, and can comprise a control unit, a drive or drive train and/or a motor. The front part of the power tool is formed by the tool thereof, which, particularly in the case where the power tool is designed as a cut-off grinder, is a disk-shaped tool. In particular, it may be referred to as a cutting disk. For the purposes of the invention, it is preferred that the spatial directions of “front” and “rear” are defined by the front power tool region formed by the tool and by the rear power tool region formed inter alia by the main body. The spatial regions “top” and “bottom” or “upper side” and “underside” of the power tool are preferably defined by the upper handle (“upper side”), which, for the purposes of the invention, is also preferably referred to as the second handle, and by the protection frame, the underside of which preferably extends on the underside of the power tool.

According to the invention, it is envisaged that the power tool has a first, circumferential handle and a second, upper handle. The first, circumferential handle preferably extends in the region of the transition between the front and the rear region of the power tool and is normally gripped with the left hand by a right-handed person when using the power tool. To this extent, the first, circumferential handle can also be used for carrying the power tool. The circumferential configuration of the first handle means that the first handle provides effective impact protection at the sides of the power tool, especially if the power tool were to fall on the right-hand or left-hand side of the tool when dropped. In particular, the circumferential configuration of the first handle protects the power tool components arranged in the main body of the power tool, such as the motor, drive or transmission, but also, of course, the rechargeable batteries. For the purposes of the invention, it is preferred that a plane in which the first handle predominantly extends extends substantially orthogonally to a longitudinal axis of the power tool. In particular, the longitudinal axis, which can be laid virtually through the power tool, extends centrally through the power tool and extends from the front region of the power tool in the direction of the rear region thereof. For the purposes of the invention, it is preferred that the plane in which the first handle predominantly extends is substantially perpendicular to the longitudinal axis of the power tool.

The second handle is normally gripped by the right hand of a right-handed user when using the power tool. According to the invention, it is envisaged that the upper handle projects beyond the main body of the power tool in a rearward spatial direction, thus ensuring that the main body and the internal components thereof are well protected against a fall and landing of the power tool on the rear side of the power tool. Owing to the fact that the second handle projects beyond the rear side of the main body of the power tool, an overlap is preferably formed. For the purposes of the invention, the term “overlap” preferably describes the distance between a substantially vertical rear wall of the main body of the power tool and a point on the rear part of the upper handle which is furthest away. This distance or overlap has the length a.

For the purposes of the invention, it is preferred that the second handle is arranged above electronics of the power tool and, on its upper side and/or its underside, comprises operating switches for the power tool. Owing to the fact that the second handle of the power tool is normally gripped by the right hand of a user, the power tool can be operated particularly well by providing the operating switch on the upper side and/or the underside of the second handle. For the purposes of the invention, it is preferred that the region of the second handle which has the at least one operating switch is designated as the grip region of the upper handle. A longitudinal axis passing centrally through the grip region preferably does not run parallel to a substrate on which the power tool can be set down but slopes at a slope angle A. In other words, it is preferred for the purposes of the invention that the second handle has a grip region, wherein the grip region is designed to slope by a slope angle alpha, wherein the slope angle alpha is in a range of from 10 to 30 degrees, preferably in a range of from 15 to 25 degrees, and most preferably in a range of from 18 to 21 cm. By means of this slope, the ergonomics of the upper handle can be considerably improved. The grip region of the upper handle is substantially perpendicular to a rear side part of the upper handle. Thus, this rear side part of the upper handle also extends at the abovementioned slope angle of about 20 degrees with respect to a substantially vertical rear wall of the main body of the power tool. Tests have shown that the slope of the second handle of the power tool considerably improves the ergonomics of the power tool.

For the purposes of the invention, it is preferred that the second handle has a rear side region, which has a height h in a range of from 70 to 150 mm, preferably in a range of from 80 to 120 mm, and most preferably in a range of from 85 to 100 mm. For the purposes of the invention, the rear side region is preferably also referred to as the rear side part. The height h can be defined as the spacing between the longitudinal axis passing centrally through the grip region of the second handle and a region in which the rear side region of the second handle merges into the power tool or the protection frame of the power tool. Details can be taken from FIG. 1.

A height h in a region of 8.5 cm has proven to be an optimum mean for good handling of the power tool and sufficient space for the reach-through region between the second handle and the upper side of the power tool, on the one hand, and compactness and robustness of the power tool on the other hand.

The power tool can comprise a protection frame, the underside of which preferably extends on the underside of the power tool. For the purposes of the invention, it is preferred that the protection frame has an L-shaped structure, in particular in a side view of the power tool. In particular, the lower leg of the “L” here extends on the underside of the power tool, while the vertically upward-projecting leg of the preferably laterally reversed “L” extends along the substantially vertical rear wall of the main body of the power tool. Such a simple L structure is preferably present both on the right-hand and on the left-hand side of the power tool, and therefore, for the purposes of the invention, the L-shaped structure is preferably also referred to as a “lateral L-shaped structure”. It preferably extends around the main body of the power tool. The two individual L-shaped structures are preferably connected to one another by connecting webs, wherein one of the connecting webs extends through an inner or reach-through space of the upper handle. A further connecting web extends in the region of the first handle and connects the two L-shaped structures to one another. For the purposes of the invention, it is preferred that the vertically upward-projecting legs of the L-shaped structure of the protection frame form the rear side thereof. For the purposes of the invention, it is preferred that the rechargeable batteries of the power tool are arranged in the interior of the protection frame. In other words, the rechargeable batteries can be surrounded by the elements of the protection frame, and thus the protection frame protects the rechargeable batteries from mechanical damage, e.g. due to a sideways fall.

For the purposes of the invention, it is preferred that there is a rounded region between the grip region and the rear side region of the second handle, wherein the rounded region has a radius R with a length in a range of from 40 to 60 mm, preferably in a range of from 45 to 55 mm, and most preferably in a range of from 48 to 52 mm. Fall tests which have been carried out have shown that a combination of an overlap of 6-7 cm and a radius R in a region of 5 cm leads to particularly effective protection for the rechargeable batteries of the power tool.

### BRIEF DESCRIPTION OF THE DRAWINGS

Further advantages will become apparent from the following description of the figures. The figures, the description and the claims contain numerous features in combination. A person skilled in the art will expediently also consider the features individually and combine them to form useful further combinations.

Identical and similar components are denoted by the same reference signs in the figures. More specifically:

FIG. 1 shows a side view of a preferred embodiment of the power tool

FIG. 2 shows a further side view of a preferred embodiment of the power tool

### DETAILED DESCRIPTION

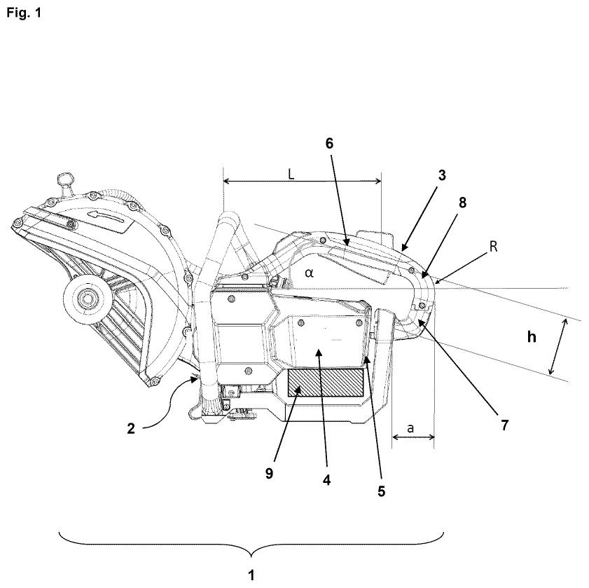

FIG. 1 shows a preferred embodiment of a power tool 1 having a first handle 2 and a second handle 3. The second handle 3 comprises a grip region 6 which can be gripped by one hand of the user of the power tool 1 when the user is working with the power tool 1. Moreover, the second handle 3 has a rear side region 7, which connects the second handle 3 to the power tool 1 or to the protection frame of the power tool 1. The grip region 6 and the rear side region 7 of the second handle 3 enclose a substantially right angle with one another, wherein the term “substantially right angle” is not an unclear concept for a person skilled in the art. A person skilled in the art knows that this is intended to mean that the grip region 6 and the rear side region 7 enclose an angle with one another which, within the limits of production accuracy, represents a 90 degree angle but may differ from exact mathematical orthogonal alignment by an angular range of +1-5 degrees. The transition from the grip region 6 to the rear side region 7 is formed by a rounded region 8. For the purposes of the invention, it is preferred that the rounded region 8 has a radius with a length of, for example, 5 cm.

For the purposes of the invention, it is preferred that the grip region 6 of the second handle 3 is designed to slope at a slope angle alpha. This slope angle is preferably in a range of from 18 to 21 degrees, thereby making it possible to provide better ergonomics of the power tool 1.

The power tool 1 has a main body 4, which can be located in a housing. The rechargeable batteries 9 of the power tool 1 can be located in a lower region of the main body 4 of the power tool 1. Receiving spaces to receive the rechargeable batteries 9 can be provided in the main body 4 of the power tool 1. For the purposes of the invention, it is preferred that the rechargeable batteries 9 are arranged in a rear, lower region of the main body 4 of the power tool 1, where they are particularly well protected from mechanical damage due to a fall. This protection is achieved, in particular, by means of the overlap of length a by which the grip region 6 of the second handle 3 extends beyond the rear side 5 of the main body 4 of the power tool 1. For the purposes of the invention, it is preferred that the proposed power tool 1 has two rechargeable batteries 9 as energy sources.

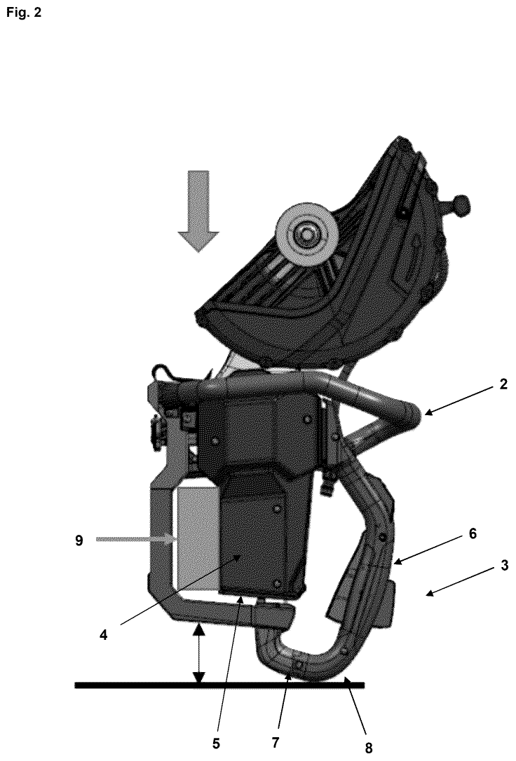

The way in which the overlap of length a contributes to protection of the power tool 1 and of the rechargeable batteries 9 in the event of a fall will be apparent from FIG. 2. FIG. 2 shows a further a side view of a preferred embodiment of the proposed power tool 1. The arrow in the upper left-hand corner of the figure is intended to symbolize the direction of a possible fall. In particular, the arrow points in the “downward” spatial direction. The arrow in the form of a line between the substrate and the rear side 5 of the power tool 1 preferably symbolizes the protection of the power tool 1 or of the rechargeable batteries 9 by the overlap of the second handle 3.

### LIST OF REFERENCE SIGNS

1 Power tool
2 First handle
3 Second handle
4 Main body
5 Rear side of the main body
6 Grip region
7 Rear side region
8 Rounded region
9 Rechargeable batteries

What is claimed is:

1-6. (canceled)

7. A power tool comprising:
a first handle;
a second handle; and
a main body, the second handle projecting beyond a rear side of the main body by a length a in order to protect the power tool in the event of a fall.

8. The power tool as recited in claim 7 wherein the length a is in a range of from 30 to 100 mm.

9. The power tool as recited in claim 8 wherein the length a is in a range of from 50 to 80 mm.

10. The power tool as recited in claim 9 wherein the length a is in a range of from 55 to 70 mm.

11. The power tool as recited in claim 7 wherein the second handle has a grip region designed to slope by a slope angle alpha, wherein the slope angle alpha is in a range of from 10 to 30 degrees.

12. The power tool as recited in claim 11 wherein the slope angle alpha is in a range of from 15 to 25 degrees.

13. The power tool as recited in claim 12 wherein the slope angle alpha is in a range of from 15 to 25 degrees.

14. The power tool as recited in claim 7 wherein the second handle has a rear side region having a height h in a range of from 70 to 150 mm.

15. The power tool as recited in claim 14 wherein the height h is in a range of from 80 to 120 mm.

16. The power tool as recited in claim 15 wherein the height h is in in a range of from 85 to 100 mm.

17. The power tool as recited in claim 14 further comprising a rounded region between a grip region and the rear side region of the second handle, wherein the rounded region has a radius R in a range of from 40 to 60 mm.

18. The power tool as recited in claim 17 wherein the radius R is in a range of from 45 to 55 mm.

19. The power tool as recited in claim 18 wherein the radius R is in a range of from 48 to 52 mm.

20. The power tool as recited in claim 7 wherein the first handle and the second handle have a spacing L in a range of from 180 to 350 mm.

21. The power tool as recited in claim 20 wherein the spacing L is in a range of from 200 to 300 mm.

22. The power tool as recited in claim 20 wherein the spacing L is in a range of from 230 to 260 mm.
